(19) United States
(12) Patent Application Publication
(10) Pub. No.: US 2026/0313380 A1
(43) Pub. Date: Oct. 8, 2026

(54) SECURITY FOR GROUPCAST SIDELINK POSITIONING

(71) Applicant: Apple Inc., Cupertino, CA (US)

(72) Inventors: Shu GUO, Beijing (CN); Alexander SIROTKIN, Hod Hasharon (IL); Dawei ZHANG, Saratoga, CA (US); Haijing HU, Los Gatos, CA (US)

(21) Appl. No.: 19/483,120

(22) PCT Filed: May 11, 2023
(86) PCT No.: PCT/CN2023/093552

§ 371 Date: Nov. 10, 2025

(51) Int. Cl. H04W 12/106; H04W 12/76; H04W 64/00; H04W 92/18

(52) U.S. Cl. CPC H04W 12/106; H04W 12/76; H04W 64/00; H04W 92/18

(57) ABSTRACT

A core network element for key management functionality for sidelink (SL) positioning for groupcast or multicast in a radio communications system, the core network element including a hardware processor and a non-transitory computer-readable medium storing key management function instructions that when executed cause the hardware processor to perform key management function operations, the key management function operations including, for a user equipment (UE) requesting registration or access to a group for SL positioning, allocating a key credential for the UE to join the group, the key credential comprising a session key comprising an integrity protection field and an encryption field, the key credential associated with a group identifier for the group corresponding to the UE.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

Aspects of the embodiments are directed to a core network element for key management functionality for sidelink (SL) positioning for groupcast or multicast in a radio communications system, the core network element including a hardware processor; and a non-transitory computer-readable medium storing key management function instructions that when executed cause the hardware processor to perform key management function operations. The key management function operations including, for a user equipment (UE) requesting registration or access to a group for SL positioning, allocating a key credential for the UE to join the group, the key credential comprising a session key comprising an integrity protection field and an encryption field, the key credential associated with a group identifier for the group corresponding to the UE.

In some embodiments, the session key comprises fields for key_member_int and key_member_int ID for integrity protection and fields for key_member_enc and key_member_enc ID for encryption. In some embodiments, the key management function operations further include determining that the session key is to be updated; and providing an updated session key with an updated key_member_int and updated key_member_enc for the UE.

In some embodiments, the session key is derived from a root key credential that includes a key_group key field and a key_group ID key field.

In some embodiments, the key management function operations further include allocating the root key credential for the UE.

In some embodiments, the session key is derived by a key derivation function (KDF) using an SL positioning string.

In some embodiments, the key management function operations further include determining that one of the root key or the session key is to be updated; and providing an updated root key with an updated key_group and key_group ID for the UE.

In some embodiments, the key management function operations include allocating the session key to the UE with group configuration information, the group configuration information including at least one of a group ID, group name, or group information.

In some embodiments, the key management function operations include providing the session key to an access and management function (AMF) for the UE to obtain during a registration procedure.

In some embodiments, the key management function operations include providing the session key to a service provider for the UE to obtain by an application layer program.

In some embodiments, the key management functionality is collocated with a location management function.

Aspects of the embodiments are directed to a method performed by a key management function of a core network element in a radio communications network, the method including configuring a session key for a user equipment (UE) to access a groupcast for sidelink positioning, the session key comprising an integrity protection field and an encryption field; and allocating the session key for the UE.

In some embodiments, the session key comprises fields for key_member_int and key_member_int ID for integrity protection and fields for key_member_enc and key_member_enc ID for encryption.

Some embodiments include determining that the session key is to be updated; and providing an updated session key with an updated key_member_int and an updated key_member_enc for the UE.

In some embodiments, the session key is derived from a root key that includes a key_group key field and a key_group ID key field.

Some embodiments include allocating the root key for the UE.

In some embodiments, the session key is derived by a key derivation function (KDF) using a SL positioning string.

Some embodiments include determining that one of the root key or the session key is to be updated based on one of a local policy or a key validity period; and providing an updated root key with an updated key_group and key_group ID for the UE.

Some embodiments include allocating the session key to the UE with group configuration information, the group configuration information including at least one of a group ID, group name, or group information.

Some embodiments include providing the session key to an access and management function (AMF) for the UE to obtain during a registration procedure.

Some embodiments include providing the session key to a service provider for the UE to obtain by an application layer program.

In some embodiments, the key management function is collocated with a location management function.

Aspects of the embodiments method performed by a user equipment (UE) operating in a radio communications network, the method including receiving, from a radio access network station, a key credential for performing sidelink positioning within a group, the key credential comprising a session key with an integrity protection field and an encryption field, the key credential comprising a group identifier identifying the group; and performing sidelink positioning using the key credential.

Some embodiments include performing a registration procedure with a radio access network; and receiving the key credential with the group identifier from the radio access network upon acceptance of the registration procedure.

Some embodiments include requesting to join the group for sidelink positioning; and upon confirmation of access to the group, receiving the key credential and group identifier for performing sidelink positioning in the group.

Some embodiments include receiving the key credential and group identifier from a service provider through an application running on the UE.

In some embodiments, the session key comprises a key_member_int field and a key_member_int identifier field for integrity protection and a key_member_enc field and a key_member_enc identifier field for encryption.

Some embodiments include receiving an updated session key, the updated session key comprising an updated key_member_int field and an updated key_member_enc field.

Some embodiments include receiving a root key credential with the session key, the root key comprising a key_group field and a key_group identifier field.

Some embodiments include receiving an updated root key credential, the updated root key comprising an updated key_group field and an updated key_group identifier field.

Some embodiments include determining that a key compromise event has occurred; requesting a key update from a core network element key management function; and receiving an updated key credential from the radio access network station.

Aspects of the embodiments are directed to a user equipment (UE) operating in a wireless cellular communications network, the UE comprising a radio frequency transceiver, a hardware processor, and a memory for storing instructions that when executed, cause the UE to perform operations include receiving, from a radio access network station, a key credential for performing sidelink positioning within a group, the key credential comprising a session key with an integrity protection field and an encryption field, the key credential comprising a group identifier identifying the group; and performing sidelink positioning using the key credential.

Some embodiments include performing a registration procedure with a radio access network; and receiving the key credential with the group identifier from the radio access network upon acceptance of the registration procedure.

Some embodiments include requesting to join the group for sidelink positioning; and upon confirmation of access to the group, receiving the key credential and group identifier for performing sidelink positioning in the group.

Some embodiments include receiving the key credential and group identifier from a service provider through an application running on the UE.

In some embodiments, the session key comprises a key_member_int field and a key_member_int identifier field for integrity protection and a key_member_enc field and a key_member_enc identifier field for encryption.

Some embodiments include receiving an updated session key, the updated session key comprising an updated key_member_int field and an updated key_member_enc field.

Some embodiments include receiving a root key credential with the session key, the root key comprising a key_group field and a key_group identifier field.

Some embodiments include receiving an updated root key credential, the updated root key comprising an updated key_group field and an updated key_group identifier field.

Some embodiments include determining that a key compromise event has occurred; requesting a key update from a core network element key management function; and receiving an updated key credential from the radio access network station.

The details of one or more embodiments of these systems and methods are set forth in the accompanying drawings and the description below. Other features, objects, and advantages of these systems and methods will be apparent from the description and drawings, and from the claims

### BRIEF DESCRIPTION OF THE DRAWINGS

FIG. 1 illustrates an example communication system that includes sidelink communications, according to some implementations.

FIG. 2 illustrates an architecture of a system 200 including a second core network (CN) in accordance with various embodiments.

FIG. 3 is a swim-lane diagram illustrating a representative process flow for allocating key credentials for a user equipment to access a group for sidelink positioning during a cell registration process in accordance with embodiments of the present disclosure.

FIG. 4 is a swim-lane diagram illustrating a representative process flow for allocating key credentials for a user equipment to access a group for sidelink positioning when the user equipment joins a group in accordance with embodiments of the present disclosure.

FIG. 5 is a swim-lane diagram illustrating two representative process flows for updating key credentials for a user equipment to access a group for sidelink positioning in accordance with embodiments of the present disclosure.

FIG. 6 illustrates an example user equipment (UE), according to some implementations.

FIG. 7 illustrates an example access node, according to some implementations.

### DETAILED DESCRIPTION

Sidelink (SL) positioning protocol (SLPP) unicast messages between user equipment (UEs) is the baseline for SL positioning. In addition, sending part of SLPP positioning signaling am0ong UEs via broadcast/groupcast is also possible. Unicast/one-to-one operation is assumed as baseline for exchange of SLPP signaling between UEs. Unicast SLPP session-based operation is supported. At least “centralized” operation is supported, i.e., operation where one UE performs range and/or position calculations based on measurement/location information relating to itself and/or other UEs. It is feasible to send at least the following positioning signaling for groupcast/broadcast (in addition to unicast) from RAN2's perspective: SL positioning capability and SL positioning assistance data. Location information is not excluded and can be further considered in normative work.

Security issues pertaining to how to protect the SL groupcast messages are described herein. The security issues (e.g., requirements for ciphering (encryption) and/or integrity) on specific information of SL positioning capability and assistance data in groupcast are described.

For link positioning over the Uu interface, the UE may receive positioning assistance data via broadcast (e.g., by a system information block such as posSIB). The posSIB may optionally be ciphered as follows:
assistanceDataElement included in IE AssistanceDataSIBelement may be ciphered using the 128-bit AES; and
the initial key is provided in two portions (C0 and D0):
C0 is provided using NAS (which is protected); and
D0 is provided in SI, which is not protected.

This disclosure describes security protection for groupcast in SL positioning. This disclosure describes a key management function (KMF) that is embodied in the core network. For example, the KMF could be collocated with location management function (LMF) or can be an independent function (or can be embodied with another function of the core network).

The key management function can perform key credential management functionality, including causing the derivation of keys, the allocation of keys, the updating of keys, and the deletion of keys, all to support SL positioning in groupcast.

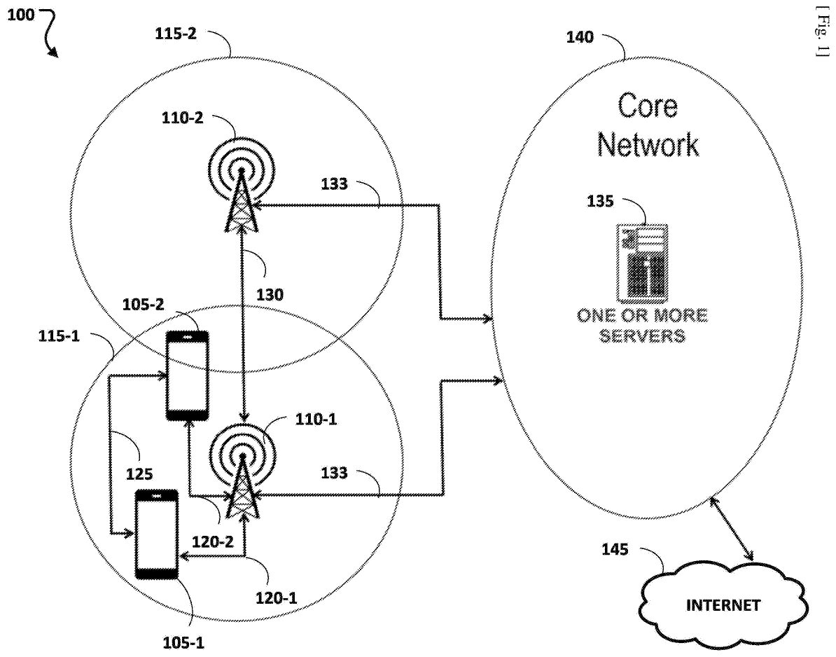

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110”or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC 5 interface for a radio resource control (RRC) signaling exchange between the UEs (also called PC5-RRC signaling, SR5 control signaling, and/or ranging/sidelink positioning protocol (RSPP) signaling). The PC5/Uu interfaces are used only as an example, and PC5 as used herein may represent various other possible wireless communications technologies that allow for direct sidelink communications between user devices, such as SR5 and RSPP, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

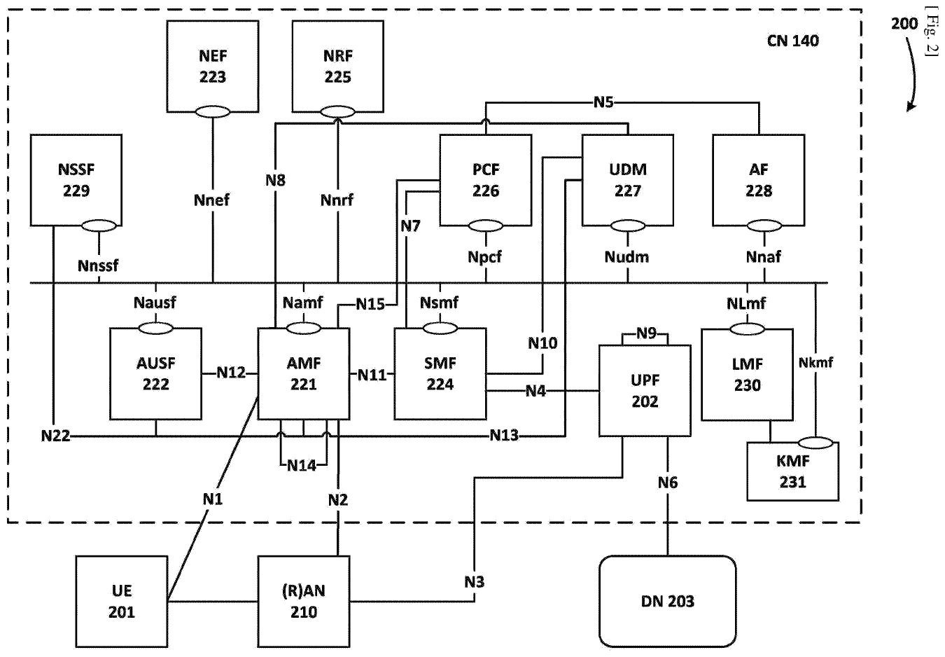

FIG. 2 illustrates an architecture of a system 200 including a second CN 140 in accordance with various embodiments. The system 200 is shown to include a UE 201, which may be the same or similar to the UEs 600; a (R) AN 210, which may be the same or similar to the RAN node 110, and which may include RAN nodes, such as gNB or ng-eNB or other base station; and a DN 203, which may be, for example, operator services, Internet access or 3rd party services; and a 5GC 220. The 5GC 220 may include an AUSF 222; an AMF 221; a SMF 224; a NEF 223; a PCF 226; a NRF 225; a UDM 227; an AF 228; a UPF 202; and a NSSF 229.

The UPF 202 may act as an anchor point for intra-RAT and inter-RAT mobility, an external PDU session point of interconnect to DN 203, and a branching point to support multi-homed PDU session. The UPF 202 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 202 may include an uplink classifier to support routing traffic flows to a data network. The DN 203 may represent various network operator services, Internet access, or third party services. DN 203 may include, or be similar to, an application server. The UPF 202 may interact with the SMF 224 via an N4 reference point between the SMF 224 and the UPF 202.

The AUSF 222 may store data for authentication of UE 201 and handle authentication-related functionality. The AUSF 222 may facilitate a common authentication framework for various access types. The AUSF 222 may communicate with the AMF 221 via an N12 reference point between the AMF 221 and the AUSF 222; and may communicate with the UDM 227 via an N13 reference point between the UDM 227 and the AUSF 222. Additionally, the AUSF 222 may exhibit an Nausf service-based interface.

The AMF 221 may be responsible for registration management (e.g., for registering UE 201, etc.), connection management, reachability management, mobility management, and lawful interception of AMF-related events, and access authentication and authorization. The AMF 221 may be a termination point for the N11 reference point between the AMF 221 and the SMF 224. The AMF 221 may provide transport for SM messages between the UE 201 and the SMF 224, and act as a transparent proxy for routing SM messages. AMF 221 may also provide transport for SMS messages between UE 201 and an SMSF (not shown by FIG. 2). AMF 221 may act as SEAF, which may include interaction with the AUSF 222 and the UE 201, receipt of an intermediate key that was established as a result of the UE 201 authentication process. Where USIM based authentication is used, the AMF 221 may retrieve the security material from the AUSF 222. AMF 221 may also include a SCM function, which receives a key from the SEA that it uses to derive access-network specific keys. Furthermore, AMF 221 may be a termination point of a RAN CP interface, which may include or be an N2 reference point between the (R) AN 210 and the AMF 221; and the AMF 221 may be a termination point of NAS (N1) signaling, and perform NAS ciphering and integrity protection.

AMF 221 may also support NAS signaling with a UE 201 over an N3 IWF interface. The N3IWF may be used to provide access to untrusted entities. N3IWF may be a termination point for the N2 interface between the (R) AN 210 and the AMF 221 for the control plane, and may be a termination point for the N3 reference point between the (R) AN 210 and the UPF 202 for the user plane. As such, the AMF 221 may handle N2 signaling from the SMF 224 and the AMF 221 for PDU sessions and QoS, encapsulate/de-encapsulate packets for IPSec and N3 tunneling, mark N3 user-plane packets in the uplink, and enforce QoS corresponding to N3 packet marking taking into account QoS requirements associated with such marking received over N2. N3IWF may also relay uplink and downlink control-plane NAS signaling between the UE 201 and AMF 221 via an N1 reference point between the UE 201 and the AMF 221, and relay uplink and downlink user-plane packets between the UE 201 and UPF 202. The N3IWF also provides mechanisms for IPsec tunnel establishment with the UE 201. The AMF 221 may exhibit an Namf service-based interface, and may be a termination point for an N14 reference point between two AMFs 221 and an N17 reference point between the AMF 221 and a 5G-EIR (not shown by FIG. 2).

The UE 201 may need to register with the AMF 221 in order to receive network services. RM is used to register or deregister the UE 201 with the network (e.g., AMF 221), and establish a UE context in the network (e.g., AMF 221). The UE 201 may operate in an RM-REGISTERED state or an RM-DEREGISTERED state. In the RM DEREGISTERED state, the UE 201 is not registered with the network, and the UE context in AMF 221 holds no valid location or routing information for the UE 201 so the UE 201 is not reachable by the AMF 221. In the RM REGISTERED state, the UE 201 is registered with the network, and the UE context in AMF 221 may hold a valid location or routing information for the UE 201 so the UE 201 is reachable by the AMF 221. In the RM-REGISTERED state, the UE 201 may perform mobility Registration Update procedures, perform periodic Registration Update procedures triggered by expiration of the periodic update timer (e.g., to notify the network that the UE 201 is still active), and perform a Registration Update procedure to update UE capability information or to re-negotiate protocol parameters with the network, among others.

The AMF 221 may store one or more RM contexts for the UE 201, where each RM context is associated with a specific access to the network. The RM context may be a data structure, database object, etc. That indicates or stores, inter alia, a registration state per access type and the periodic update timer. The AMF 221 may also store a 5GC MM context that may be the same or similar to the (E) MM context discussed previously. In various embodiments, the AMF 221 may store a CE mode B Restriction parameter of the UE 201 in an associated MM context or RM context. The AMF 221 may also derive the value, when needed, from the UE's usage setting parameter already stored in the UE context (and/or MM/RM context).

CM may be used to establish and release a signaling connection between the UE 201 and the AMF 221 over the N1 interface. The signaling connection is used to enable NAS signaling exchange between the UE 201 and the CN 140, and comprises both the signaling connection between the UE and the AN (e.g., RRC connection or UE-N3IWF connection for non-3GPP access) and the N2 connection for the UE 201 between the AN (e.g., RAN 210) and the AMF 221. The UE 201 may operate in one of two CM states, CM-IDLE mode or CM-CONNECTED mode. When the UE 201 is operating in the CM-IDLE state/mode, the UE 201 may have no NAS signaling connection established with the AMF 221 over the N1 interface, and there may be (R) AN 210 signaling connection (e.g., N2 and/or N3 connections) for the UE 201. When the UE 201 is operating in the CM-CONNECTED state/mode, the UE 201 may have an established NAS signaling connection with the AMF 221 over the N1 interface, and there may be a (R) AN 210 signaling connection (e.g., N2 and/or N3 connections) for the UE 201. Establishment of an N2 connection between the (R) AN 210 and the AMF 221 may cause the UE 201 to transition from CM-IDLE mode to CM-CONNECTED mode, and the UE 201 may transition from the CM-CONNECTED mode to the CM-IDLE mode when N2 signaling between the (R) AN 210 and the AMF 221 is released.

The SMF 224 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 201 and a data network (DN) 203 identified by a Data Network Name (DNN). PDU sessions may be established upon UE 201 request, modified upon UE 201 and 5GC 220 request, and released upon UE 201 and 5GC 220 request using NAS SM signaling exchanged over the N1 reference point between the UE 201 and the SMF 224. Upon request from an application server, the 5GC 220 may trigger a specific application in the UE 201. In response to receipt of the trigger message, the UE 201 may pass the trigger message (or relevant parts/information of the trigger message) to one or more identified applications in the UE 201. The identified application(s) in the UE 201 may establish a PDU session to a specific DNN. The SMF 224 may check whether the UE 201 requests are compliant with user subscription information associated with the UE 201. In this regard, the SMF 224 may retrieve and/or request to receive update notifications on SMF 224 level subscription data from the UDM 227.

The SMF 224 may include the following roaming functionality: handling local enforcement to apply QoS SLAs (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 224 may be included in the system 200, which may be between another SMF 224 in a visited network and the SMF 224 in the home network in roaming scenarios. Additionally, the SMF 224 may exhibit the Nsmf service-based interface.

The NEF 223 may provide means for securely exposing the services and capabilities provided by 3GPP network functions for third party, internal exposure/re-exposure, Application Functions (e.g., AF 228), edge computing or fog computing systems, etc. In such embodiments, the NEF 223 may authenticate, authorize, and/or throttle the AFs. NEF 223 may also translate information exchanged with the AF 228 and information exchanged with internal network functions. For example, the NEF 223 may translate between an AF-Service-Identifier and an internal 5GC information. NEF 223 may also receive information from other network functions (NFs) based on exposed capabilities of other network functions. This information may be stored at the NEF 223 as structured data, or at a data storage NF using standardized interfaces. The stored information can then be re-exposed by the NEF 223 to other NFs and AFs, and/ or used for other purposes such as analytics. Additionally, the NEF 223 may exhibit an Nnef service-based interface.

The NRF 225 may support service discovery functions, receive NF discovery requests from NF instances, and provide the information of the discovered NF instances to the NF instances. NRF 225 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 225 may exhibit the Nnrf service-based interface.

The PCF 226 may provide policy rules to control plane function(s) to enforce them, and may also support unified policy framework to govern network behavior. The PCF 226 may also implement an FE to access subscription information relevant for policy decisions in a UDR of the UDM 227. The PCF 226 may communicate with the AMF 221 via an N15 reference point between the PCF 226 and the AMF 221, which may include a PCF 226 in a visited network and the AMF 221 in case of roaming scenarios. The PCF 226 may communicate with the AF 228 via an N5 reference point between the PCF 226 and the AF 228; and with the SMF 224 via an N7 reference point between the PCF 226 and the SMF 224. The system 200 and/or CN 140 may also include an N24 reference point between the PCF 226 (in the home network) and a PCF 226 in a visited network. Additionally, the PCF 226 may exhibit an Npcf service-based interface.

The UDM 227 may handle subscription-related information to support the network entities' handling of communication sessions, and may store subscription data of UE 201. For example, subscription data may be communicated between the UDM 227 and the AMF 221 via an N8 reference point between the UDM 227 and the AMF. The UDM 227 may include two parts, an application FE and a UDR (the FE and UDR are not shown by FIG. 2). The UDR may store subscription data and policy data for the UDM 227 and the PCF 226, and/or structured data for exposure and application data (including PFDs for application detection, application request information for multiple UEs 201) for the NEF 223. The Nudr service-based interface may be exhibited by the UDR 221 to allow the UDM 227, PCF 226, and NEF 223 to access a particular set of the stored data, as well as to read, update (e.g., add, modify), delete, and subscribe to notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 224 via an N10 reference point between the UDM 227 and the SMF 224. UDM 227 may also support SMS management, wherein an SMS-FE implements the similar application logic as discussed previously. Additionally, the UDM 227 may exhibit the Nudm service-based interface.

The AF 228 may provide application influence on traffic routing, provide access to the NCE, and interact with the policy framework for policy control. The NCE may be a mechanism that allows the 5GC 220 and AF 228 to provide information to each other via NEF 223, which may be used for edge computing implementations. In such implementations, the network operator and third party services may be hosted close to the UE 201 access point of attachment to achieve an efficient service delivery through the reduced end-to-end latency and load on the transport network. For edge computing implementations, the 5GC may select a UPF 202 close to the UE 201 and execute traffic steering from the UPF 202 to DN 203 via the N6 interface. This may be based on the UE subscription data, UE location, and information provided by the AF 228. In this way, the AF 228 may influence UPF (re) selection and traffic routing. Based on operator deployment, when AF 228 is considered to be a trusted entity, the network operator may permit AF 228 to interact directly with relevant NFs. Additionally, the AF 228 may exhibit an Naf service-based interface.

The NSSF 229 may select a set of network slice instances serving the UE 201. The NSSF 229 may also determine allowed NSSAI and the mapping to the subscribed S-NSSAIs, if needed. The NSSF 229 may also determine the AMF set to be used to serve the UE 201, or a list of candidate AMF(s) 221 based on a suitable configuration and possibly by querying the NRF 225. The selection of a set of network slice instances for the UE 201 may be triggered by the AMF 221 with which the UE 201 is registered by interacting with the NSSF 229, which may lead to a change of AMF 221. The NSSF 229 may interact with the AMF 221 via an N22 reference point between AMF 221 and NSSF 229; and may communicate with another NSSF 229 in a visited network via an N31 reference point (not shown by FIG. 2). Additionally, the NSSF 229 may exhibit an Nnssf service-based interface.

As discussed previously, the CN 140 may include an SMSF, which may be responsible for SMS subscription checking and verification, and relaying SM messages to/from the UE 201 to/from other entities, such as an SMS-GMSC/IWMSC/SMS-router. The SMS may also interact with AMF 221 and UDM 227 for a notification procedure that the UE 201 is available for SMS transfer (e.g., set a UE not reachable flag, and notifying UDM 227 when UE 201 is available for SMS).

The CN 140 also includes a Location Management Function (LMF) 230. LMF 230 is a network entity in the 5G Core Network (5GC) 140 that supports the following functionality: location determination for a UE; obtains downlink location measurements or a location estimate from the UE; obtains uplink location measurements from the NG RAN; and obtains non-UE associated assistance data from the NG RAN. The LMF offers to other network functions the NLmf location.

The CN 140 also includes a key management function (KMF) 231. KMF 231 can be an independent functional element or can be collocated with the LMF 230. The KMF 231 can provide key management functionality. Key management functionality includes, but is not limited to, key credential allocation, key credential generation/derivation (e.g., via a key derivation function), key updating, and key deletion. Such functions are described in more detail below.

In embodiments, the LMF 230 can be perform functions performed by the KMF 231.

The CN 140 may also include other elements that are not shown by FIG. 2, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 2). Individual NFs may share a UDSF for storing their respective unstructured data or individual NFs may each have their own UDSF located at or near the individual NFs. Additionally, the UDSF may exhibit an Nudsf service-based interface (not shown by FIG. 2). The 5G-EIR may be an NF that checks the status of PEI for determining whether particular equipment/ entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 2 for clarity. In one example, the CN 140 may include an Nx interface, which is an inter-CN interface between an MME and the AMF 221 in order to enable interworking between CN 140. Other example interfaces/ reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

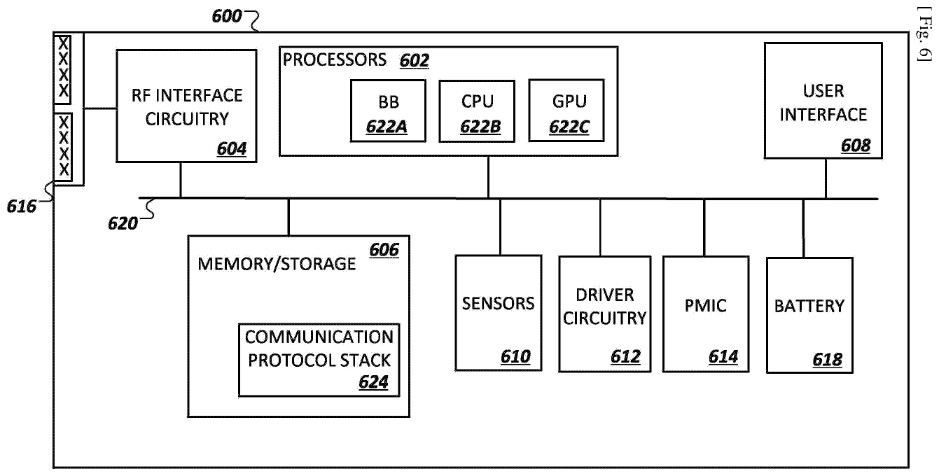

UE 105-1 and 105-2 and UE 201 can be the same or similar as the UE described in FIG. 6

As an overview of the security features for UE SL positioning in groupcast, the following issues are presented:
Issue#1: Key allocation
Issue#2: Key credentials
Issue#3: Key update

Each of these three topics is discussed in more detail below:

### Issue#1: Key Allocation

Key allocation concerns how and when keys are allocated to one or more UEs. Key allocation can follow one of three options:
Option#1: the key credentials can be allocated to the UE in registration procedure.
Option#2: the key credentials can be allocated when UE joins the group for SL positioning. In Option#2, the keys shall be allocated together with group ID/group name/other group information. In this way, the message to deliver the key information and the group information are protected.
Option#3: The key could be allocated from the application layer.

### Issue#1, Option#1:

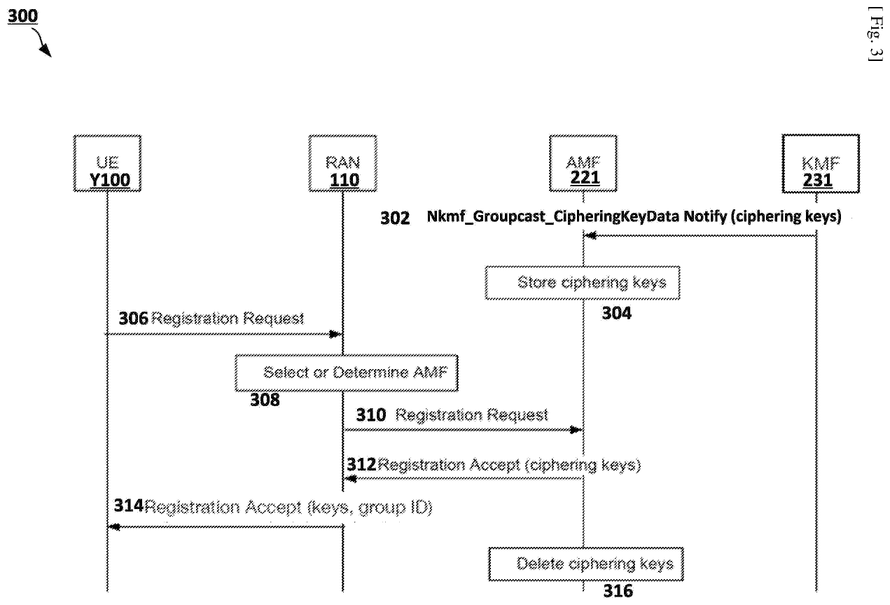

Option#1: the key credentials can be allocated in registration procedure, and the ciphering keys are sent together with the group ID for the group(s) that the UE is associated with. FIG. 3 is a swim-lane diagram 300 illustrating a representative process flow for allocating key credentials for a user equipment to access a group for sidelink positioning during a cell registration process in accordance with embodiments of the present disclosure. The swim-lane diagram includes message exchanges between a UE 600, a RAN element 110 (such as a gNB or ng-eNB or other base station), an AMF 221 in the core network, and a KMF 231 in the core network (though it is understood that the LMF 230 can also perform key management functions if configured to do so).

At (302), the KMF 231 sends ciphering keys for posSIB to AMF 221. At (304), AMF 221 stores ciphering keys.

At some point in time (prior to expiration of the keys, though key updates are described later), at (306), a UE 600 sends a Registration Request to the RAN node 110 to register with the network. The Registration Request can include an indication that the UE 600 is requesting ciphering keys, which can be a specific request for ciphering keys for groupcast SL positioning or a general request for ciphering keys for use during operation within the network.

At (308), the RAN node 110 (e.g., gNB) selects or identifies an AMF 221. The RAN node 110 selects an AMF 221 based on the UE's location and the service requirements of the UE 600. The RAN uses the information available in the UE's initial registration request, such as the UE's identity, location, and requested services, to determine which AMF 221 to forward the request to. At (310), after the RAN node 110 selects an appropriate AMF, the RAN node 110 forwards the Registration Request to the selected AMF 221 for further processing.

At (312), assuming that the Registration Request is Accepted, the AMF 221 returns Registration Accept, which can include ciphering key(s) for the UE (assuming that the UE is subscribed to receive the ciphering key(s). Group ID is also sent to the UE with the ciphering keys, so that Group ID can be used as part of the UE authentication/authorization for participating in groupcast SL positioning.

At (314), RAN node 110 forwards Registration Accept to the UE 600. The UE 600 stores keys as long as validity time has not expired and it remains in Tracking Area (TA) where keys are valid. The keys may only be used in some specific TA; when UE changes TA, the UE needs to register to that TA (via AMF) and get new keys for this current TA. At (316), the AMF can delete ciphering keys that are no longer valid. Keys can become invalid based on expiration, based on an indication of a leak or security breach, or for other reasons. When keys are deleted, AMF 221 can receive new keys from KMF 231, which is described as an key update procedure below.

If the UE 600 is able to fetch the key(s) during the registration procedure, then the keys must have been allocated by KMF 231. That is, the LMF/KMF 230/231 determined in advance which key is to be sent to which UE. The predetermination of keys depends on the group management procedure. For example, when UE registers to this service, LMF 230 may decide which group this UE will be in. Every group will use different keys for security. The Group management procedure is not in this scope of this IDF, it rely on RAN/SA2 groups to decide.

In some embodiments, the KMF 231 manages one key for groupcast SL positioning. If KMF 231 only manages one key for groupcast SL positioning, then this key will be delivered to all UEs subscribed to the SL position service provided by the corresponding LMF 230.

In embodiments, the KMF 231 manages more than one key for different predefined groups. If the KMF 231 manages more than one key for different predefined groups, the UE 600 will be allocated automatically to a specific group when registering to the network, and ciphering keys and group ID information will be delivered based on the group assignment. The policies on how to group UEs depends on the MNO configuration.

### Issue#1, Option#2:

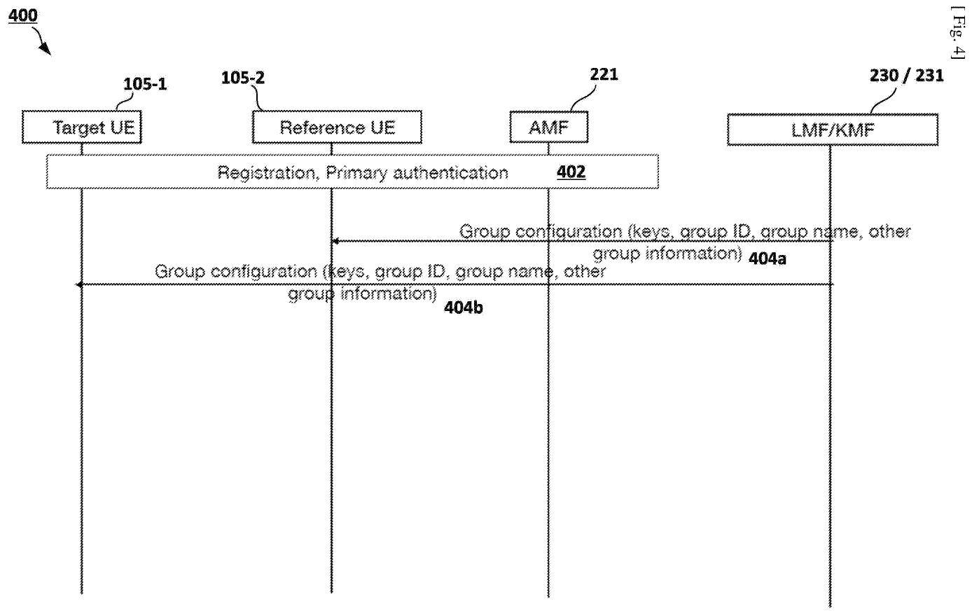

Option#2: the key credentials can be allocated when UE joins the group for SL positioning. In Option#2, the keys shall be allocated together with group ID/group name/other group information. In this way, the message to deliver the key information and the group information are protected. FIG. 4 is a swim-lane diagram 400 illustrating a representative process flow for allocating key credentials for a user equipment to access a group for sidelink positioning when the user equipment joins a group in accordance with embodiments of the present disclosure. In FIG. 4, two UEs are shown, which can be UEs in the same group or in different groups. For this example, the UEs are in different groups to illustrate that different group identification information is sent to each UE with unique ciphering keys.

At (402), the UEs would have undergone a registration procedure with the network, which can include primary authentication and other handshaking, exchange of configuration information, service subscriptions, capabilities, etc. The LMF/KMF 230/231 can at that point establish ciphering keys for UEs that are part of the network based on the registration procedure. In this example, however, the UEs are not joined to the group upon registration, but are attempting to join at some point after registration. The process for the UE to join a group is outside the scope of this disclosure. Briefly, as part of the joining procedure, the UE sends a Join Group Request (JGR) message to the core network, requesting to join the group. The JGR message can include the group identity and the multicast/broadcast address received from the RAN node. The CN function checks if the requested group is authorized and available for the UE. If the group is available and authorized, the CN function responds with a Join Group Response (JGRsp) message, which includes the group identity and other group-specific parameters. In embodiments, the parameters can include key credentials along with the group identification information for the UE to use to perform groupcast SL positioning.

For example, at (404a), for Reference US 105-2, the LFM/KMF 230/231 can provide a group configuration message (e.g., via a transparent link through gNB) for groupcast SL positioning. The group configuration message can include key credentials for groupcast SL positioning, as well as group identification information. The group identification information can include one or more of group ID, group name, or other group information. The keys shall be allocated together with group ID/group name/other group information, so that no new messages are introduced. In this way, the message to deliver the key information and the group information shall be protected. Likewise at 404b, the target UE 105-1 is sent group configuration message that includes key credentials and group identification information. In this example, the group configuration message sent to target UE 105-1 can be different than the group configuration message sent to reference UE 105-1. But it is understood that the group configuration messages for both UEs can include overlapping information, such as when the reference UE 105-2 and the target UE 105-1 are in the same group.

### Issue#1, Option#3:

Option#3: The key could be allocated from the application layer. The service provider that provides the UE a service through the application layer can also provide key credentials and group identification information for authenticating and authorizing the UE to participate in groupcast SL positioning. In this case, the service provider can obtain key credentials and group identification information from the core network, and can authenticate the UE via subscription information.

### Issue#2: Key Credentials

The specific format for the key credentials is described here. The KMF 231 can create (or have created) and store key credentials. It is assumed here symmetric algorithms are used for encryption and integrity protection, such algorithms can include NEA 1/2/3 for encryption and NIA 1/2/3 for integrity protection.

### Option#1:

In embodiments, the KMF 231 allocates a root key credential and a session key for the UE. In this case, the root key credential contains fields for Key_group (the key itself) and Key_group ID. The Key_group ID provides a group identifier string that corresponds to the group that the UE is authenticated to join, and is linked to the root key cipher field Key_group. The session key is also provided, and includes fields for encryption (Key_member_enc, Key_member_enc ID) and integrity protection (Key_member_int, Key_member_int ID). The session keys are derived from key derivation function (KDF) based on: (root key (Key_group), “SL positioning” ). KDF is specified in Annex B. 2.0 of TS 33.220.

### Option#2:

In embodiments, only sessions keys are allocated by KMF 231. Here, the session key includes fields for encryption (Key_member_enc, Key_member_enc ID) and integrity protection (Key_member_int, Key_member_int ID). Key_member_int is used for integrity protection, while the Key_member_enc is used for encryption.

### Issue#3: Key Update

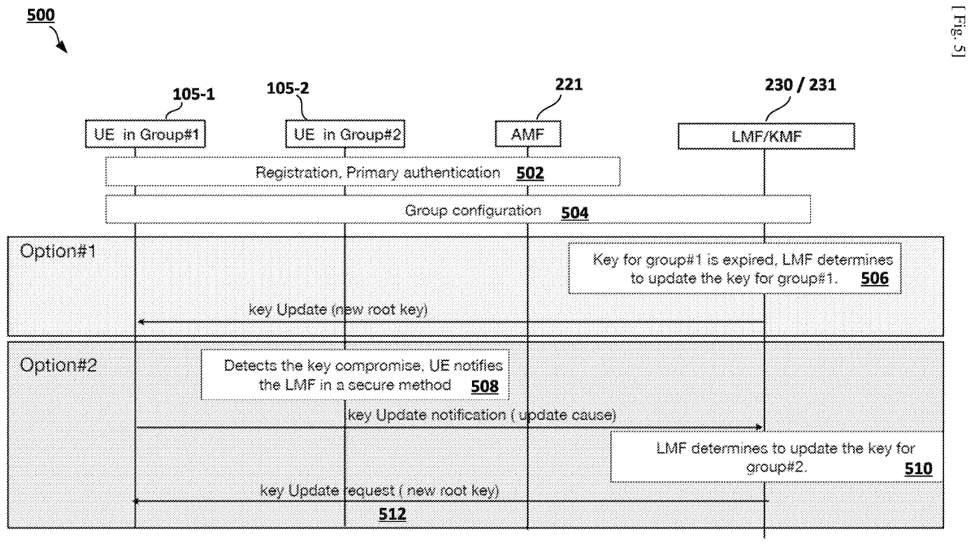

FIG. 5 is a swim-lane diagram 500 illustrating two representative process flows for updating key credentials for a user equipment to access a group for sidelink positioning in accordance with embodiments of the present disclosure. The swim-lane diagram 500 includes messages exchanged between a UE in group 1 105-1, a UE in group 2 105-2, an AMF 221, and a KMF 231 (which can be embodied in an LMF 230).

### Issue#3: Key Update:

Key update policy and procedure can be organized based on the nature of the key credentials, as described above for Issue#2. At (502), the UEs undergo registration, primary authentication by the AMF 221. At (504), the group configuration is also performed by the LMF/KMF 230/231.

For Issue#2, Option#1, when both root key credential and session key are allocated, the KMF 231 only needs to update the Key_group and Key_group ID, which is sent (e.g., by LMF/KMF 230/231 or via AMF 221) to all the members. The group members will update the corresponding key_member_X and key_member_X ID for each of integrity protection (int) and encryption (enc). During the subsequent communication, when UEs are communicating with each other, the corresponding key ID (Key_group ID) shall be included to make sure all the group members are using the same key.

For Issue#2, Option#2, when only session keys are provided to the UEs, when the KMF 231 determines to update the key, it will sent the new key_member_int and key_member_enc to all the members, and all the UEs in the same group will use the new session key for ciphering. The corresponding key_member_X ID can be sent together with the messages.

### Key Update Policy:

Issue#3, Option#1: the policy on when to update the key could be decided by the KMF based on the local policy. FIG. 5 shows in (506) that the LMF/KMF 230/231, an example of the local policy can include the expiration of the key (e.g., for group 1). In that case, the LMF/KMF 230/231 can decide to update the key for group 1. The LMF/KMF 230/231 can send the update to the group 1 UEs (such as UE 105-1) with a new root key credential or a new session key, as described above.

Issue#3, Option#2. The key update can be triggered by an event. For example, when any UE detects the key leakage, it shall sent alert to KMF reporting the key leakage and request to update the key. In FIG. 5, at (508), a group 1UE 105-1 can detect a key compromise (such as a key leakage), and can notify the LMF/KMF 230/231 in a secure method. At (510), the LMF/KMF 230/231 can determine to update the key for group 1, and can trigger such an update. At (512), the LMF/KMF 230/231 can send the update to the group 1 UE 105-1, in a manner similar to what is described above.

FIG. 6 illustrates an example UE 600, according to some implementations. The UE 600 may be similar to and substantially interchangeable with UEs 105 (or 105-1 or 105-2) of FIG. 1 or UE 201 of FIG. 2.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, one or more antenna(s) 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/ output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves into electrical signals. The antenna elements may be arranged into one or more antenna panels. The antenna(s) 616 may have antenna panels that are omnidirectional, directional, or a combination thereof to enable beamforming and multiple input, multiple output communications. The antenna(s) 616 may include microstrip antennas, printed antennas fabricated on the surface of one or more printed circuit boards, patch antennas, phased array antennas, etc. The antenna(s) 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

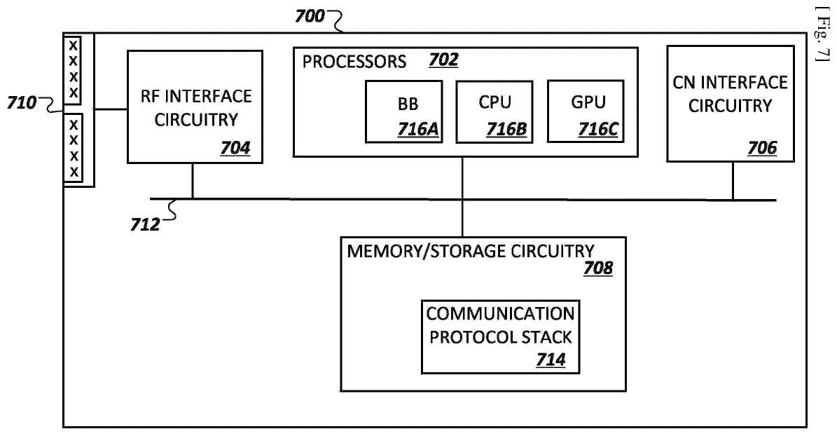

FIG. 7 illustrates an example access node 700 (e.g., a base station or gNB), according to some implementations. The access node 700 may be similar to and substantially interchangeable with base stations 110. The access node 700 may include processors 702, RF interface circuitry 704, core network (CN) interface circuitry 706, memory/storage circuitry 708, and one or more antenna(s) 710.

The components of the access node 700 may be coupled with various other components over one or more interconnects 712. The processors 702, RF interface circuitry 704, memory/storage circuitry 708 (including communication protocol stack 714), antenna(s) 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

1-40. (canceled)

41. A core network function configured to, when executing instructions stored in a memory, perform operations comprising:
receiving a first message from a user equipment (UE), the first message comprising a request for a sidelink positioning group key; and
in response to the first message, outputting a second message for transmission to the UE, the second message comprising (i) the sidelink positioning group key, (ii) a group identifier associated with the sidelink positioning group key, and (iii) ciphering and integrity information.

42. The core network function of claim 41, the operations comprising assigning a group member identifier to the UE.

43. The core network function of claim 42, wherein the second message comprises the group member identifier of the UE.

44. The core network function of claim 41, the operations comprising determining a validity time for the sidelink positioning group key.

45. The core network function of claim 41, wherein the sidelink positioning group key is used for secure broadcast or groupcast communication.

46. The core network function of claim 41, the operations comprising determining that the UE is authorized to use a sidelink positioning service associated with the sidelink positioning group key.

47. The core network function of claim 41, wherein receiving the first message from the UE comprises receiving the first message over a secure connection between the UE and the core network function.

48. The core network function of claim 41, wherein the sidelink positioning group key is used to derive a sidelink positioning integrity key and a sidelink positioning encryption key.

49. One or more processors configured to, when executing instructions stored in a memory, perform operations comprising:
sending a first message to a core network function, the first message comprising a request for a sidelink positioning group key; and
in response to the first message, receiving a second message comprising (i) the sidelink positioning group key, (ii) a group identifier associated with the sidelink positioning group key, and (iii) ciphering and integrity information.

50. The one or more processors of claim 49, the operations comprising determining a sidelink positioning integrity key and a sidelink positioning encryption key based at least in part on the sidelink positioning group key and the ciphering and integrity information.

51. The one or more processors of claim 49, wherein the second message comprises a group member identifier of a UE.

52. The one or more processors of claim 49, the operations comprising determining a validity time for the sidelink positioning group key.

53. The one or more processors of claim 49, wherein the sidelink positioning group key is used for secure broadcast or groupcast communication.

54. The one or more processors of claim 49, wherein sending the first message to the core network function comprises sending the first message over a secure connection between a UE and the core network function.

55. The one or more processors of claim 54, wherein the UE is authorized to use a sidelink positioning service associated with the sidelink positioning group key.

56. The one or more processors of claim 49, wherein the core network function comprises a key management function.

57. A method comprising:
receiving a first message from a UE, the first message comprising a request for a sidelink positioning group key; and
in response to the first message, transmitting a second message to the UE, the second message comprising (i) the sidelink positioning group key, (ii) a group identifier associated with the sidelink positioning group key, and (iii) ciphering and integrity information.

58. The method of claim 57, comprising assigning a group member identifier to the UE.

59. The method of claim 58, wherein the second message comprises the group member identifier of the UE.

60. The method of claim 57, comprising determining a validity time for the sidelink positioning group key.
